(19) United States
(12) Patent Application Publication
(10) Pub. No.: US 2015/0198132 A1
(43) Pub. Date: Jul. 16, 2015

(54) DEVICE FOR HEATING AT LEAST ONE COMPONENT, IN PARTICULAR AN INTERNAL COMBUSTION ENGINE OF A VEHICLE

(71) Applicant: Valeo Systemes de Controle Moteur, Cergy Saint Christophe (FR)

(72) Inventors: Damien Alfano, Le Pecq (FR); Florian Mayot, Betheny (FR)

(73) Assignee: Valeo Systemes de Controle Moteur, Cergy Saint Christophe (FR)

(21) Appl. No.: 14/420,047

(22) PCT Filed: Aug. 1, 2013
(86) PCT No.: PCT/FR2013/051871

§ 371 Date: Feb. 6, 2015

(30) Foreign Application Priority Data
Aug. 8, 2012 (FR) 1257682

(51) Int. Cl. F02N 19/02; C09K 5/16

(52) U.S. Cl. CPC F02N 19/02; C09K 5/16

(57) ABSTRACT

A device (1) for heating at least one component (21), the device (1) comprising: —a pipe (2) capable of conveying a reaction fluid, —a reactor (3) capable of receiving a reagent likely to cause an exothermic reaction with the reaction fluid, the reactor (3) comprising at least one inlet for reaction fluid linked to the pipe (2) and at least one outlet for reaction fluid linked to the pipe (2), and —a circuit (10) for regenerating the reagent, the device comprising a generator (4) configured to generate a pressure lower than that inside the reactor (3) in an area of the pipe (4).

The present invention relates to the heating of at least one component. This component is, for example, a vehicle combustion engine. The invention notably, although not exclusively, applies to the heating of the combustion engine during starting of same. This combustion engine is, for example, a gasoline or diesel oil internal combustion engine.

Heating the combustion engine as it starts may make it possible to reduce the fuel consumption and/or the emission of pollutants. This heat may also, when the weather is extremely cold, be transmitted to the cabin in order to improve the comfort of the users of the vehicle.

Existing solutions for heating a combustion engine when a vehicle is starting include, for example: the use of a heater plug, encapsulation of the engine, enriching of the air/fuel mixture in order more quickly to achieve better engine output, the use of various external heating elements fixed to the bottom of the engine block, the use of an immersion heater immersed in the oil of the engine block.

These various solutions are not truly satisfactory in terms of consumption and/or of cost and/or of life and/or of the efficiency with which heat is transferred to the combustion engine.

Also known are reagents, such as zeolite, capable of reacting in a highly exothermal fashion with a reaction fluid and of being regenerated later.

Application DE 39 22 737 discloses a device for heating a component comprising, in series: a reactor able to bring about an exothermal reaction between a reagent and a reaction fluid, and a reservoir of reaction fluid. A pump allows forced circulation of the reaction fluid to the reactor.

There is a need to allow a component, notably a combustion engine, for example a vehicle combustion engine, to be heated in a simple, efficient and inexpensive way.

The invention meets this need, according to one of the aspects of the invention, using a device for heating at least one component, the device comprising:
a pipe able to carry a reaction fluid,
a reactor able to receive a reagent capable of bringing about an exothermal reaction with the reaction fluid, the reactor comprising at least one reaction-fluid inlet connected to the pipe and at least one reaction-fluid outlet connected to the pipe, and
a circuit for the regeneration of the reagent, the device comprising a generator configured to generate, in a zone of the pipe, a pressure lower than that in the reactor.

The device makes it possible to make the reagent and the reaction fluid react in the reactor in order to release heat, notably in the form of vapor. The presence of the generator allows this heat to be transferred into the pipe via the reaction-fluid outlet, and for the reaction fluid to be heated in the pipe downstream of the reactor. The reaction fluid leaving the device thus heated can then transmit this heat to the component. Vapor is, for example, aspirated into the pipe by virtue of the generator and the reaction fluid in the liquid state in the pipe downstream of the reactor is thus heated.

The level of pressure generated by the generator in a zone of the pipe may make it possible to cause the heat given off by the reaction in the reactor to be transferred into the pipe.

The reactor may be mounted in parallel with a portion of the pipe. Said portion of the pipe then extends between the branch connected to the reaction-fluid inlet of the reactor and the branch connected to the reaction-fluid outlet of the reactor.

Said portion of the pipe may have the same structure as the rest of the pipe, for example the same diameter in the case of a tubular pipe.

Regenerating the reagent may generate heat, for example in the form of vapor, and the generator allows this vapor to be aspirated via the reaction-fluid outlet in order to heat the reaction fluid traveling along the pipe without entering the reactor. The reaction fluid leaving the device is thus heated and allows this heat to be transmitted to the component. Vapor is, for example, aspirated into the pipe thanks to the generator and the reaction fluid in the liquid state in the pipe is thus heated.

Unlike the case with other architectures, there is no need to provide a heat exchanger in order to transfer the heat in the reactor to the reaction fluid carrying the heat to the component that is to be heated as this transfer is accomplished by contact in the pipe. The device can therefore be somewhat unobtrusive and easy to incorporate into existing structures.

The generator may be active, i.e. require a power supply in order to generate the depression in a zone of the pipe. It is, for example, a pump arranged in the branch connecting the reaction-fluid outlet to the pipe. In that case, a depression is created in the zone of the pipe where said branch joins the pipe.

As an alternative, the generator may be passive, i.e. does not need a power supply in order to generate a depression in a zone of the pipe. The pipe may thus comprise a water aspirator forming the generator, the reaction-fluid inlet being connected to the pipe upstream of the water aspirator and the reaction-fluid outlet being connected to the lateral aspiration intake of the water aspirator. In that case, a depression is created in the water aspirator and in the zone of the pipe downstream of the water aspirator.

The term “water aspirator” is used for any mechanism that employs the Venturi effect and surface tensions in order to achieve a minimal pressure, which is notably the saturated vapor pressure of the fluid passing through the water aspirator.

With such an example of a generator, a proportion of the reaction fluid travels along the pipe and the water aspirator without entering the reactor, while the other proportion of the reaction fluid reacts exothermally with the reagent in the reactor so that the water aspirator allows this heat to be transferred into the pipe via the reaction-fluid outlet, and allows the reaction fluid to be heated in the pipe. Vapor is, for example, aspirated by the water aspirator and the reaction fluid in the pipe in the liquid state is thus heated.

When the reagent is regenerated, the circulation of reaction fluid in the pipe and the water aspirator without entering the reactor allows heat, notably in the form of vapor, to be aspirated via the reaction-fluid outlet to heat the reaction fluid travelling along the pipe without entering the reactor. The water aspirator thus behaves like a vacuum pump.

In another of the aspects thereof, the invention meets the above need using a device for heating at least one component, the device comprising:
a pipe able to carry a reaction fluid, said pipe comprising a water aspirator,
a reactor able to receive a reagent capable of bringing about an exothermal reaction with the reaction fluid, the reactor comprising at least one reaction-fluid inlet and at least one reaction-fluid outlet, the reaction-fluid inlet being connected to the pipe upstream of the water aspirator and the reaction-fluid outlet being connected to the lateral aspiration intake of the water aspirator, and
a circuit for the regeneration of the reagent.

The device may comprise an inlet valve configured to selectively interrupt the fluidic communication between the pipe and the reaction-fluid inlet of the reactor. Depending on the position of this inlet valve, the reaction fluid travels along the pipe without entering the reactor or the reaction fluid is split between a proportion that travels through the pipe without entering the reactor and a proportion that enters the reactor. The reactor is therefore positioned in parallel with that portion of the pipe situated between the branch connected to the reaction-fluid inlet and the branch connected to the reaction-fluid outlet.

Within the meaning of the invention, “valve” means any means for interrupting or allowing a fluidic communication.

The inlet valve may be controllable. It is, for example, a valve provided with a controllable actuator. As an alternative, the inlet valve may be incorporated into an injector that is operated when there is desire for the reaction fluid to enter the reactor.

The ratio between the flow rate of the proportion of reaction fluid entering the reactor and the flow rate of the proportion of reaction fluid travelling along the pipe without entering the reactor is, for example, between 1% and 5%, being for example of the order of 1.5%. The device may comprise an outlet valve configured to selectively interrupt the fluidic communication between the reaction-fluid outlet of the reactor and the pipe.

The outlet valve may or may not be controllable. It is, for example, a nonreturn valve. The opening or closing of the outlet valve may be dependent only on the difference between the pressure in the reactor and the pressure in the pipe where the pipe and the branch connecting the reaction-fluid outlet and the pipe meet. In the absence of reaction in the reactor, the circulation of reaction fluid along the pipe may cause the valve to open in order to aspirate into the pipe the air that remains in the reactor.

A further subject of the invention, according to another of the aspects thereof, is an assembly for heating at least one component, comprising:
a device as defined hereinabove,
said component to be heated, and
an exchange circuit through which the reaction fluid travels and which is connected to the pipe, said exchange circuit being configured to transfer the heat in the reactor to the component.

The exchange circuit and the pipe may together form a closed circuit. One and the same fluid may circulate in succession through the exchange circuit and through the pipe. It is possible for no heat exchanger or condenser to be interposed between the pipe and the exchange circuit.

The closed circuit thus obtained may be devoid of a condenser. The vapor leaving the reactor may condense in the pipe upon contact between this vapor and the reaction fluid, and the heat released by this condensation heats the reaction fluid leaving the device.

One and the same fluid, namely the reaction fluid, can be used to:
react with the reagent exothermally, and
transmit the heat resulting from this reaction to the component that is to be heated.

The component is, for example, a combustion engine and the exchange circuit and the pipe may form the cooling circuit of this combustion engine.

The reactor may be configured in such a way that the maximum volume of reaction fluid in the reactor is between 20 and 50% of the maximum volume of reaction fluid in the closed circuit formed by the exchange circuit and the pipe.

When the reagent is zeolite and the reaction fluid is an aqueous solution, as defined hereinafter, the exothermal reaction is the adsorption of water by the zeolite, and the amount of zeolite in the reactor may be such that the volume of reaction fluid adsorbed during this exothermal reaction is between 20 and 30%, being notably equal to 25%, of the volume of reaction fluid in the closed circuit before the reaction occurs.

When the component is a combustion engine, the regeneration circuit may be formed by a portion of the exhaust gas circuit of the combustion engine.

The combustion engine is, for example, a gasoline or diesel oil internal combustion engine.

The cooling circuit may comprise a pump, a thermostat and a heat exchanger allowing an exchange of heat between the cooling circuit and the engine. The device may be mounted in series in the closed circuit with the engine and/or the pump for example.

It is possible for the assembly to be devoid of any other heat exchanger and condenser.

The radiator, or any other element in the exchange circuit, may form an expansion volume encouraging heat present in the reactor to be aspirated into the pipe.

A further subject of the invention, according to another aspect thereof, is a method of heating at least one component of an assembly comprising, aside from said component:
an exchange circuit through which a reaction fluid travels, and
a device for heating the component, the device comprising:
   a pipe connected to the exchange circuit,
   a reactor receiving a reagent capable of bringing about an exothermal reaction with the reaction fluid, the reactor comprising at least one reaction-fluid inlet and at least one reaction-fluid outlet, the reaction-fluid inlet being connected to the pipe and the reaction-fluid outlet being connected to the pipe,
   a circuit for regenerating the reagent, and
   a generator configured to generate in a zone of the pipe a pressure lower than that in the reactor,

in which method the heat in the reactor is transferred at least to the component via the reaction fluid.

A further subject of the invention, according to another of the objects thereof, is a method of heating at least one component of an assembly comprising, aside from said component:
an exchange circuit through which a reaction fluid travels, and
a device for heating the component, the device comprising:
   a pipe, said pipe being connected to the exchange circuit and comprising a water aspirator,
   a reactor receiving a reagent capable of bringing about an exothermal reaction with the reaction fluid, the reactor comprising at least one reaction-fluid inlet and at least one reaction-fluid outlet, the reaction-fluid inlet being connected to the pipe upstream of the water aspirator and the reaction-fluid outlet being connected to the lateral aspiration intake of the water aspirator, and
   a circuit for regenerating the reagent, in which method the heat in the reactor is transferred at least to the component via the reaction fluid.

All or some of the features mentioned hereinabove in relation to the device or the assembly apply to the methods hereinabove.

In particular, the reactor may be mounted in parallel with a portion of the pipe. Furthermore, the level of pressure generated by the generator in a zone of the pipe may make it possible to cause the heat released by the reaction in the reactor to be transferred into the pipe.

A controllable inlet valve may be positioned in such a way as to selectively interrupt the fluidic communication between the pipe and the reactor, and actions may be performed on this valve so as to allow a proportion of the reaction fluid to circulate through the reactor so as to bring about the exothermal reaction the heat of which is transmitted at least to the component by the other proportion of the reaction fluid circulating through the pipe without entering the reactor. This inlet valve for example forms part of an injector. When it is desired to heat the component, action is performed on the inlet valve in order to bring about the reaction.

Regenerating the reagent may release heat into the reactor, and this heat is transmitted at least to the component by the reaction fluid circulating in the pipe without entering the reactor. During regeneration, the inlet valve may be controlled in such a way as to prevent the reaction fluid in the pipe from entering the reactor. In this way, when there is a desire to heat the component even though the reaction has already taken place, the reagent can be regenerated in order to generate heat in the reactor and transmit this heat to the component.

In one exemplary embodiment of the invention, the reagent is zeolite and the reaction fluid is an aqueous solution. Within the meaning of the present invention, an “aqueous solution” denotes both water on its own and a mixture of water with one or more other components in greater or lesser proportions with respect to the water. One example of such an aqueous solution is a mixture of water and of glycol, for example in equal proportions.

The zeolite may take the form of beads piled up in the reactor. The zeolite may be anhydrous before the reaction with the reaction fluid.

The exothermal reaction in the reactor may be a reaction of adsorption of water by the anhydrous zeolite, the zeolite notably having a specific heat capacity of 300 Wh per 1 kg of zeolite.

In this example, the exothermal reaction between the zeolite and the water corresponds to the adsorption of water by the zeolite and leads to a vaporizing of water which is aspirated into the reaction-fluid outlet by virtue of the depression generated in the pipe by the generator, notably in instances where use is made of a water aspirator by virtue of the circulation of reaction fluid in the liquid state in the water aspirator. The heat released by the reaction in the form of vapor is thus forced to reach the pipe where it condenses upon contact with the liquid aqueous solution. The heat of condensation can therefore heat the aqueous solution.

Still in this example, the regeneration of the zeolite corresponds to the desorption of water from the zeolite, the desorbed water being vaporized then aspirated into the reaction-fluid outlet by virtue of the depression generated by the generator in the pipe notably in cases in which use is made of a water aspirator by virtue of the circulation of reaction fluid in the liquid state in the water aspirator. The heat released by the regeneration reaction in the form of vapor therefore reaches the pipe where it condenses upon contact with the liquid aqueous solution. The heat of condensation may therefore heat this aqueous solution.

The same component may be heated by the heat derived from the reaction between the reaction fluid and the reagent and by the heat derived from the regeneration of the reagent. As an alternative, the heat derived from the regeneration of the reagent may be used to heat another component.

The method may be implemented for heating at least one combustion engine, the exchange circuit then being the cooling circuit of the engine and the regeneration circuit forming a portion of the exhaust gas circuit. As mentioned hereinabove, the exchange circuit may be devoid of a condenser and only an exchanger exchanging heat with the combustion engine provided. The reaction fluid in this case is the coolant, notably a liquid mixture of water and glycol.

The cooling circuit may also comprise other pipes, a thermostat, a pump and a radiator.

The combustion engine may be a motor vehicle engine.

As an alternative, the method may be applied within a motor vehicle but in some way other than for heating the combustion engine of this vehicle. The component may be at least one of the following: a gearbox, a cabin heating and/or climate-control system and a deicing system, a vehicle window wiping system or a battery of the vehicle.

The method may be implemented when the combustion engine is started, notably in order to heat this engine.

As an alternative, the method may be implemented prior to the starting of the vehicle engine, this engine then not necessarily being a combustion engine. Implementation of the method may be performed in response to an item of information imposed by the user of the vehicle or may be performed automatically, for example following detection of an action by the user, such as the unlocking of the doors of the vehicle, the insertion of the ignition key or the opening of a door of the vehicle, for example.

The method thus allows certain components of the vehicle to be preconditioned. This preconditioning may make it possible to deice the windows of the vehicle or heat the gearbox oil, for example. This preconditioning may also or as an alternative allow the oil or the water in the engine and/or the cabin of the vehicle and/or the product for wiping the vehicle window(s) to be heated.

The invention may be better understood from reading the following description of a nonlimiting embodiment thereof and from studying the attached drawing in which:

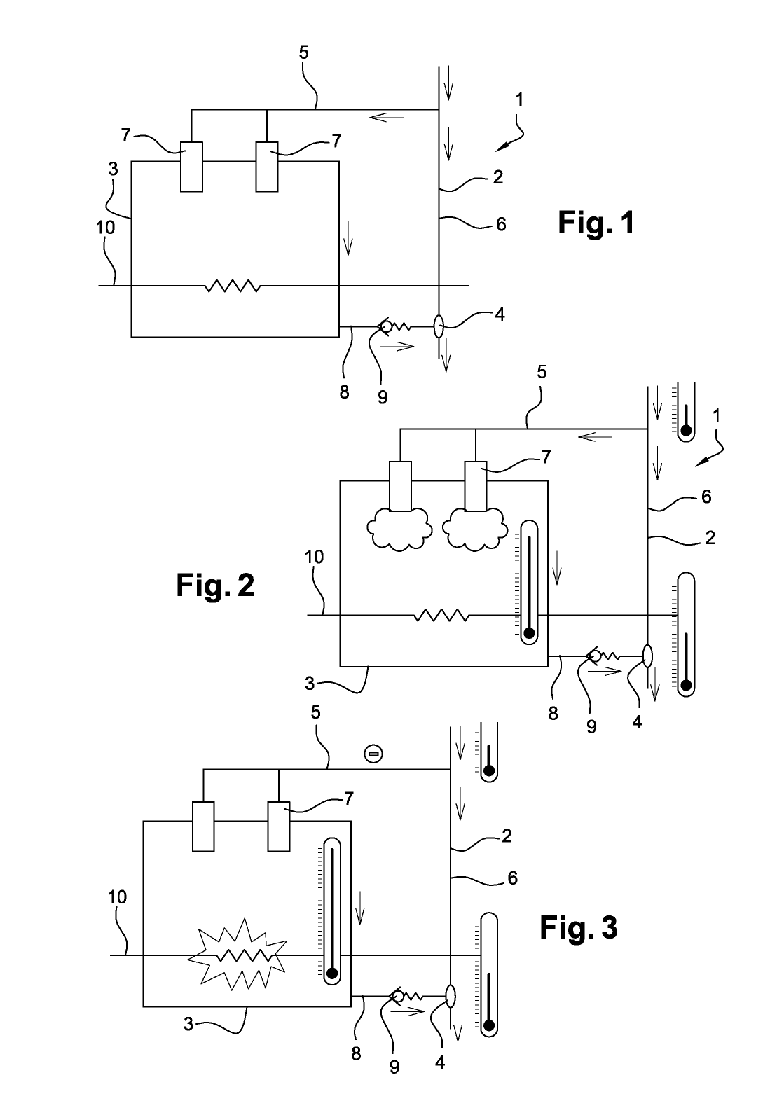

FIG. 1 schematically depicts a heating device according to one embodiment of the invention,

FIGS. 2 to 4 illustrate various phases of use of the device of FIG. 1 for generating heat, and

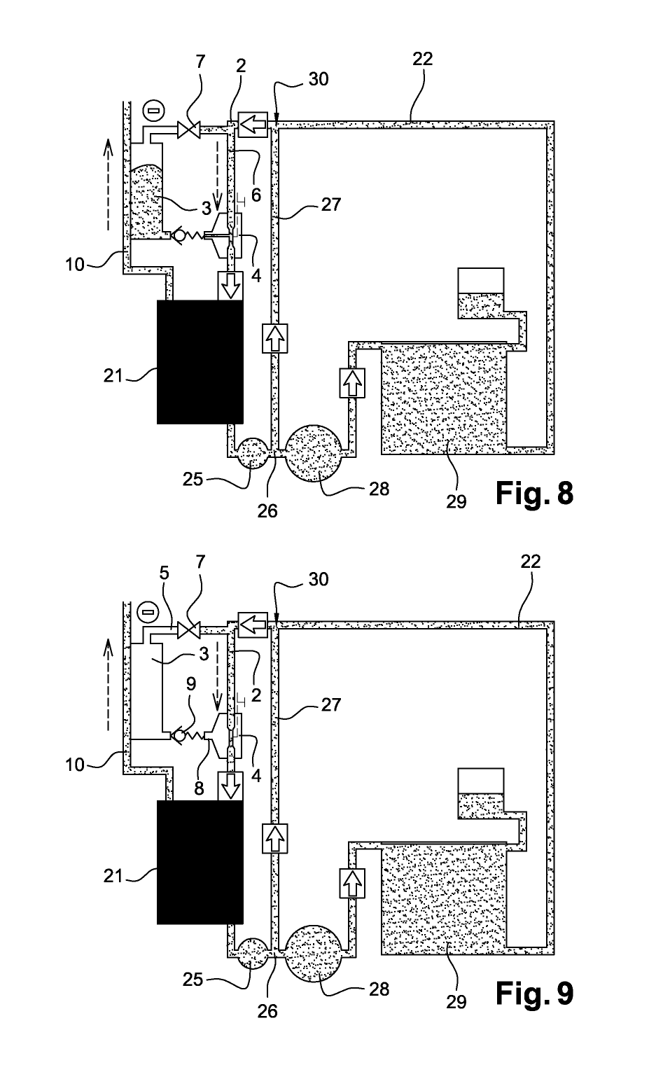

FIGS. 5 to 9 illustrate one example of the use of the device of FIGS. 1 to 4 for heating a motor vehicle combustion engine.

An example of a heating device according to one embodiment of the invention will be described with reference to FIG. 1. This device may be used to heat one or more components, for example a combustion engine, notably of a motor vehicle, as will be seen hereinafter.

As depicted in FIG. 1, the device 1 comprises a pipe 2 able to carry a reaction fluid and a reactor 3 in which a reagent that reacts with the reaction fluid exothermally is arranged. The reactor 3 may be sealed with respect to the outside. As may be seen, the device 1 comprises a generator 4 configured to generate in a zone of the pipe 2 a pressure lower than the pressure obtaining in the reactor 3. In the example that will be described, the generator 4 is formed by a water aspirator 4 with which the pipe 2 is provided. A branch 5 starts in the pipe 2 upstream of the water aspirator 4 and this branch 5 allows the reactor 3 to be supplied with reaction fluid. In the example described, the reactor 3 comprises two reaction-fluid inlets, but the invention is not restricted to any particular number of reaction-fluid inlets.

Each reaction-fluid inlet in the example considered is associated with an inlet valve 7 allowing fluidic communication between the pipe 2 and the reactor 3 to be interrupted or authorized. This valve 7 may be a shutter coupled to an actuator. As an alternative and as depicted, this valve 7 may be incorporated into an injector.

The reactor 3 may comprise one or more reaction-fluid outlets connected by a branch 8 to the lateral aspiration intake of the water aspirator 4. As depicted in FIG. 1, one or more outlet valves 9 are provided to allow or interrupt fluidic communication between the reactor 3 and the water aspirator 4. In the example considered, a nonreturn valve is used by way of an outlet valve 9.

Thus, depending on the state of the inlet 7 and outlet 9 valves, circulation of reaction fluid in the branch 5, the reactor 3 and the branch 8 is possible in parallel with the circulation through the portion 6 of the pipe 2 which is arranged between the branches 5 and 8.

The device 1 further comprises a circuit 10 for the regeneration of the reagent in the reactor 3. The regeneration circuit in the example described takes the form of one or more pipes extending through the reactor 3. These may be straight pipes or pipes each of which make one or more outward/return passes through the reactor 3.

In the example described hereinafter, the reagent is zeolite and the reaction fluid is an aqueous solution formed of a mixture of water and of glycol. To heat one or more components, the device 1 may be used cyclically, each cycle comprising in succession:
a reaction phase during which an exothermal reaction between the reaction fluid and the reagent takes place, this phase being initiated when the reaction fluid is brought into contact with the reagent. The heat released is then transmitted to the component.
a regeneration phase during which the reagent and the reaction fluid are returned to the state they occupied prior to the exothermal reaction. This regeneration phase is notably carried out by conveying heat to the reactor.
a storage phase in which the device is at rest.

When the reagent is zeolite and the reaction fluid is an aqueous solution formed of water and of glycol, the exothermal reaction may be the adsorption of water by the zeolite and the regeneration may be obtained by strongly heating the water-saturated zeolite. Regeneration may therefore correspond to the desorption of the water adsorbed previously. This water released in the form of vapor can then condense. Depending on the temperature in the reactor 3, the glycol may be vaporized and accompany the water vapor. During the regeneration phase, the temperature of the zeolite may be raised to around 250° C.

The various constituents of the device 2 may be configured so that the heating phase allows around 15 kW of heating power to be supplied for around two minutes and so that the regeneration phase lasts approximately twenty minutes.

Progress through an operating cycle of the device 2 will now be described with reference to FIGS. 2 to 4.

When the reaction phase is to be initiated, action is carried out on the inlet valve or valves 7 in order to place the pipe 2 and the reactor 3 in fluidic communication. Reaction fluid therefore, via the reaction-fluid inlet or inlets, reaches the reactor 3 in which it is poured onto the zeolite whereas another proportion of the reaction fluid simultaneously passes through the portion 6 of the pipe 2. The ratio between the diameter of the portion 6 of the pipe 2 between the branches 5 and 8 and the diameter of the branch 5 may be chosen such that approximately 1.5% of the reaction fluid circulating through the pipe 2 upstream of the branch 5 enters the reactor 3.

Because the reaction fluid in the reactor 3 is at an excess by comparison with the zeolite, a proportion of the water is adsorbed by the zeolite in order to react exothermally while the other proportion of this water is vaporized as a result of the heat released by the reaction.

The reaction causes the temperature and pressure in the reactor 3 to rise. The temperature reaches for example 150° C. in the chamber whereas the pressure therein may reach 250 mbar. Because of the difference between the pressure obtaining in the reactor 3 and that in the water aspirator 4, the vapor in the reactor 3 is aspirated into the branch through the outlet valve 9 and reaches the water aspirator 4 via the lateral aspiration intake thereof. The vapor then comes into contact with the reaction fluid flowing in liquid form in the portion 6 of the pipe 2. This contact causes the vapor to condense and causes the reaction fluid downstream of the water aspirator 4 to heat up, as can be seen in FIG. 2 in view of the temperature diagrams present in that figure. The reaction fluid thus heated can then transmit this heat to the component that is to be heated.

When the reaction phase is over, the regeneration phase can take place, immediately or after a time delay. Where there is a desire to regenerate the zeolite ready for the next reaction, fluid at high temperature is circulated via the regeneration circuit 10. This passage of a hot fluid through the regeneration circuit allows the temperature in the reactor 3 to be raised.

Because of this rise in temperature, the water-saturated zeolite at the end of the reaction phase will then be desorbed. The water released is vaporized because of the temperature in the reactor 3. This vapor is then aspirated into the branch 8 as far as the water aspirator 4 where it encounters the reaction fluid circulating in liquid state in the portion 6 of the pipe 2. During this regeneration phase, the inlet valve 7 may be closed so that reaction fluid cannot be poured from the pipe 2 into the reactor 3.

As already mentioned, contact between the reaction fluid in the liquid state in the water aspirator 4 and the vapor resulting from the regeneration causes this vapor to condense and the reaction fluid to heat up downstream of the water aspirator 4.

The reaction fluid thus heated can transmit its heat to the same component as during the reaction phase or to another component.

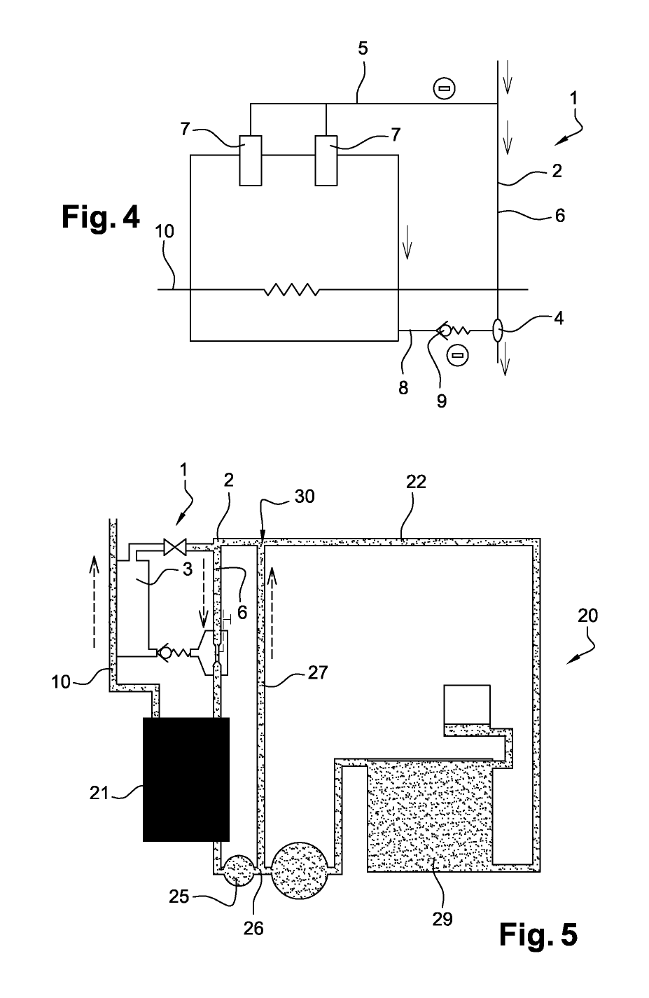

FIG. 4 depicts the storage phase corresponding to non-use of the device 1 for heating. During this phase, which follows the regeneration phase and precedes the reaction phase, the inlet valve 7 is closed. The pressure in the reactor 3 is close to 0 mbar and the passage of reaction fluid in the liquid state through the portion 6 of the pipe 2 and through the water aspirator 4 may allow any air still present in the reactor 3 to be aspirated.

The device 1 that has just been described with reference to FIGS. 1 to 4 thus allows heat to be generated cyclically in order to heat one or more components, each cycle allowing two distinct generations of heat:
when the exothermal reaction is in progress, and
when the reagent is being regenerated at the end of this reaction.

Furthermore, the device 1 allows a transfer of heat in the reactor 3 to the reaction fluid downstream of the water aspirator 4 without a condenser or heat exchanger.

One example of use of the device 1 that has just been described will now be described with reference to FIGS. 5 to 10. In this example, the device 1 is used to heat a combustion engine when it is being started, this engine notably belonging to a motor vehicle. This for example is a gasoline or diesel oil internal combustion engine.

The device 1 is therefore incorporated into an assembly 20 comprising, aside from the device 1, the combustion engine 21 and an exchange circuit 22. The pipe 2 in this example is connected to the exchange circuit 22 in order therewith to form a closed circuit through which the reaction fluid travels. The closed circuit in this example of use forms the cooling circuit of the engine 21 and the reaction fluid is the engine coolant, typically a mixture of water and glycol.

The pipe 2 in the example depicted is mounted in series with the combustion engine 21 and a pump 25. The exchange circuit 22 in this example further comprises a branch-off downstream of the pump 25 between a return pipe 27 allowing the pumped coolant to recirculate to the pipe 2 and an inlet of a thermostat 28. The thermostat is mounted in series with a radiator 29 the outlet of which joins the return pipe 27 at a point 30 in order to form the inlet of the pipe 2.

The ratio between the maximum volume of coolant in the reactor 3 and the maximum volume of coolant in the closed circuit here is between 0.2 and 0.5.

Furthermore, the amount of zeolite in the reactor 3 may be such that the exothermal reaction consumes approximately 25% of the total volume of water in the closed circuit, this total volume of water being defined as the fraction of water in the coolant in the entire closed circuit. In this example, the regeneration circuit 10 forms part of the exhaust gas circuit for the gases leaving the combustion engine 21.

Prior to use of the device 1 for heating the combustion engine 21, the temperature in the exchange circuit 22 may be around 20° C. at a pressure of 1 bar.

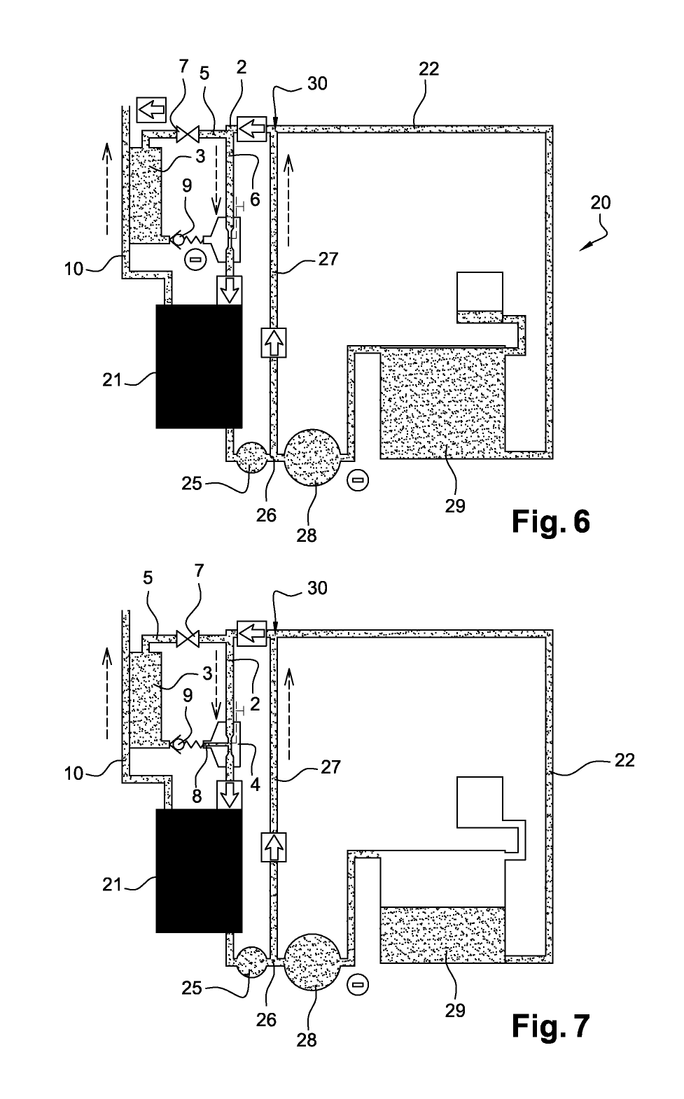

When the combustion engine 21 starts, the coolant circulates in the closed circuit as can be seen in FIG. 6. The reaction phase in the device 1 can then be initiated by acting on the inlet valve 7 in order to bring the coolant into contact with the zeolite in the reactor 3 in order to release heat, as mentioned before. Because of the simultaneous circulation of coolant through the portion 6 of the pipe 2 and the water aspirator 4, a depression is created in the water aspirator 4.

When, as a result of the reaction in the reactor 3, the pressure therein increases sufficiently, the water aspirator 4 aspirates the vapor given off by the exothermal reaction into the branch 8, as depicted in FIG. 7. The temperature in the reactor 3 reaches, for example, 150° C. at a pressure of 300 mbar. This vapor comes into contact with the coolant in the water aspirator 4 and condenses so that the coolant downstream of the water aspirator 4 and upstream of the engine 21 is heated by this heat of condensation. The coolant thus heated reaches, for example, a temperature of around 70° C. at a pressure of 1.1 bar. By virtue of a heat exchanger which has not been depicted, the coolant transfers this heat to the combustion engine 21.

At the end of this phase, as depicted in FIG. 7, a proportion of the coolant has been consumed by the exothermal reaction in the reactor 3, so that the liquid level in the radiator 29 drops. At the end of the reaction phase, action is performed on the inlet valve 7 to interrupt the injection of coolant into the reactor 3. When there is a desire to regenerate the zeolite, the exhaust gases are circulated through the regeneration circuit 10. The rise in temperature in the reactor 3 leads to the desorption of the water from the zeolite. This water is vaporized and aspirated into the water aspirator 4, then condensing upon contact with the coolant circulating in the portion 6 of the pipe 2. During this phase, the temperature in the reactor 3 reaches for example 250° C. at a pressure of 600 mbar. The coolant downstream of the water aspirator can adopt a temperature of 90° C. at a pressure of 1.1 bar. The coolant can then transmit this heat to the combustion engine 21 for example.

When there is no desire to use the device 1, namely during the phase of rest of the device 1, the coolant circulates only through the exchange circuit 22 and the portion 6 of the pipe 2 without entering the reactor 3 so that everything is as if the assembly 20 did not have a reactor 3. At the start of this rest phase, the temperature in the reactor may be around 250° C. at a pressure of 200 mbar and the temperature of the coolant may be around 80° C. at a pressure of 1.1 bar.

The invention is not restricted to the example that has just been described.

Although in this example the device 1 is mounted in series with the component that is to be heated, in this instance the combustion engine 21, the device 1 as an alternative may be arranged in the return pipe 27.

Furthermore, the generator 4 may be produced otherwise than by using a water aspirator, for example using a pump placed in the branch 8 downstream of the outlet valve 9.

In alternative forms that have not been described, the device 1 can be used to heat one or more components of a vehicle at times other than when the engine of this vehicle is being started. The device 1 may for example heat one or more components before the engine is started, thus preconditioning this or these component(s).

This preconditioning may be the result of a command given by the user of the vehicle before the latter starts the vehicle, for example by pressing on a button that starts the device 1. As an alternative, the preconditioning is the result of a command generated automatically, for example as a result of detection that a user has entered the vehicle, notably as a result of the ignition key being inserted, the doors being unlocked or a door being opened.

In the case of such preconditioning, the device 1 may thus, prior to the starting of the engine, transfer heat to a system for deicing windows, for example the windshield of the vehicle, to the gearbox of the vehicle, notably to heat the oil thereof, or to the cabin of the vehicle, for the sake of the comfort of the user or users of the vehicle.

The combustion engine may, for example, be other than a vehicle, and in particular motor vehicle, combustion engine.

In the examples described hereinabove, when the reagent is zeolite, the latter may take the form of beads with large-sized pores, for example pore sizes of between 0.3 and 0.8 nm, in order to encourage contact between the reaction fluid and the zeolite.

The expression “comprising a” is to be understood as being synonymous with the expression “comprising at least a/comprising at least one” unless specified to the contrary.

1. A device for heating at least one component, the device comprising:
a pipe able to carry a reaction fluid;
a reactor able to receive a reagent capable of bringing about an exothermal reaction with the reaction fluid, the reactor comprising at least one reaction-fluid inlet connected to the pipe and at least one reaction-fluid outlet connected to the pipe; and
a circuit for the regeneration of the reagent,
the device comprising a generator configured to generate, in a zone of the pipe, a pressure lower than that in the reactor so as to cause the heat released in the reactor to be transferred into the pipe.

2. The device as claimed in claim 1, the reactor being mounted in parallel with a portion of the pipe.

3. The device as claimed in claim 1, the pipe comprising a water aspirator forming the generator, the reaction-fluid inlet being connected to the pipe upstream of the water aspirator and the reaction-fluid outlet being connected to the lateral aspiration intake of the water aspirator.

4. The device as claimed in claim 1, comprising an inlet valve configured to selectively interrupt the fluidic communication between the pipe and the reaction-fluid inlet of the reactor.

5. The device as claimed in claim 4, the inlet valve being controllable.

6. The device as claimed in claim 1, comprising an outlet valve configured to selectively interrupt the fluidic communication between the reaction-fluid outlet of the reactor and the pipe.

7. The device as claimed in claim 6, the outlet valve being a nonreturn valve.

8. An assembly for heating at least one component, comprising:
a device as claimed in claim 1;
said component to be heated; and
an exchange circuit through which the reaction fluid travels and which is connected to the pipe, said exchange circuit being configured to transfer the heat in the reactor to the component.

9. The assembly as claimed in claim 8, the component being a combustion engine, the exchange circuit and the pipe forming the cooling circuit of the combustion engine and the regeneration circuit being formed by a portion of the exhaust gas circuit of the combustion engine.

10. A method of heating at least one component of an assembly comprising, aside from said component:
an exchange circuit through which a reaction fluid travels; and
a device for heating the component,
the device comprising:
a pipe connected to the exchange circuit,
a reactor receiving a reagent capable of bringing about an exothermal reaction with the reaction fluid, the reactor comprising at least one reaction-fluid inlet and at least one reaction-fluid outlet, the reaction-fluid inlet being connected to the pipe and the reaction-fluid outlet being connected to the pipe,
a circuit for regenerating the reagent, and
a generator configured to generate in a zone of the pipe a pressure lower than that in the reactor so as to cause the heat generated in the reactor to be transferred into the pipe,
in which method the heat in the reactor is transferred at least to the component via the reaction fluid.

11. The method as claimed in claim 10, wherein a controllable inlet valve is positioned in such a way as to selectively interrupt the fluidic communication between the pipe and the reactor, and wherein actions are performed on this inlet valve to allow a proportion of the reaction fluid to circulate through the reactor to bring about the exothermal reaction the heat of which is transmitted at least to the component by the other proportion of the reaction fluid circulating through the pipe without circulating through the reactor.

12. The method as claimed in claim 10, wherein the regeneration of the reagent releases heat into the reactor, and wherein this heat is transmitted at least to the component by the other proportion of the reaction fluid circulating through the pipe without circulating through the reactor.

13. The method as claimed in claim 10, wherein the reagent is zeolite and the reaction fluid is an aqueous solution.

14. The method as claimed in claim 13, in which the exothermal reaction between the zeolite and the water corresponds to the adsorption of water by the zeolite and leads to a vaporization of water which is aspirated in the reaction-fluid outlet by virtue of the depression generated by the generator in the pipe.

15. The method as claimed in claim 13, wherein the regeneration of the zeolite corresponds to the desorption of water from the zeolite, the desorbed water being vaporized then aspirated into the reaction-fluid outlet by virtue of the depression generated by the generator in the pipe.

16. The method as claimed in claim 10, the method being implemented to heat at least one motor vehicle combustion engine, the exchange circuit and the pipe forming the cooling circuit of the engine and the regeneration circuit forming a portion of the exhaust gas circuit.
